(19) United States
(12) Patent Application Publication
(10) Pub. No.: US 2022/0176322 A1
(43) Pub. Date: Jun. 9, 2022

(54) APPARATUS AND METHOD FOR REDUCING CONCENTRATION POLARIZATION AND MEMBRANE FOULING ON MEMBRANE SURFACE IN A FILTER UNIT

(71) Applicant: SEDIGN SOLUTIONS PRIVATE LIMIED, Bangalore (IN)

(72) Inventor: S. Nikhil Das, Bangalore (IN)

(73) Assignee: SEDIGN SOLUTIONS PRIVATE LIMITED, Bangalore (IN)

(21) Appl. No.: 17/599,361

(22) PCT Filed: Mar. 29, 2020
(86) PCT No.: PCT/IN2020/050303

§ 371 Date: Sep. 28, 2021

(30) Foreign Application Priority Data
Mar. 29, 2019 (IN) 20191012506

(51) Int. Cl. B01D 65/02; B01D 65/08; B01D 61/02; B01D 61/12; C02F 1/44

(52) U.S. Cl. CPC B01D 65/02; B01D 65/08; B01D 61/025; B01D 61/12; C02F 2303/16; B01D 2321/2075; B01D 2321/2058; B01D 2321/40; C02F 1/441

(57) ABSTRACT

An apparatus for reducing concentration polarization and/or membrane fouling on a membrane surface in a filter unit (102) during a membrane separation process and/or a filter cleaning process. The apparatus includes (i) a signal generator (106) that generates electrical signals when there is a fluid flow in the filter unit (102) and (ii) an ultrasonic transducer assembly (108) that receives the electrical signal from the signal generator to generate ultrasonic waves using one or more ultrasonic transducers (604). The ultrasonic waves pass through the filter unit (102) during the membrane separation process and/or the filter cleaning process and generate at least one of a turbulence in the flow of fluid or a vibration on the membrane surface to dislodge particles clogging the membrane surface, thereby reducing the concentration polarization and/or the membrane fouling on the membrane surface of the filter unit (102), which in turn increasing membrane permeability and efficiency.

### BACKGROUND

### Technical Field

The embodiments herein generally relate to membrane separation, more particularly relate to an apparatus and method for improving efficiency of membrane separation and/or filter cleaning process by reducing concentration polarization and/or membrane fouling on a membrane surface in a filter unit during the membrane separation process and/or the filter cleaning process using a non-invasive and non-destructive vibrational energy source.

### Description of the Related Art

Kidneys play a vital role in removal of toxins and excess water from the human body. The removed toxins and the excess water are eliminated from the human body through urination. Proper functioning kidneys prevent accumulation of the extra water, waste, and other impurities in the human body.

According to the National Kidney foundation, End Stage Renal Disease (ESRD) occurs in the patients when their kidneys are performing only 10 to 15 percent of their normal function. This may lead to non-removal of toxins and fluid, which may increase to dangerous levels, in the patient's body. In such cases, the patients are prescribed dialysis. The dialysis is a process where their blood is drawn and purified externally by means of a machine comprising a filter, known as a dialyzer. Without dialysis, salts, and other waste products may accumulate in the blood, and may poison the body and damage other organs of the body. The dialysis is a membrane separation process that separates solutes from a solution through a semi permeable membrane. During dialysis, the blood from the human body/patient may flow through the membrane of the dialyzer and the dialysate may flow around the membrane. Since, the dialysate is low in concentration of toxins, diffusion of toxins happens from the blood into the dialysate through the pores of the semi permeable membrane. The accumulation of the removed toxins and other particles like protein present in the blood may cause a clogging effect during the process, at the pores of the semi-permeable membrane, which is called as concentration polarization. Concentration polarization and/or membrane fouling limit the efficiency of the membrane separation processes and/or the filter cleaning processes involving the semi-permeable membrane. In case of dialysis, this reduction in efficiency leads to dialysis inadequacy. The membrane fouling comprises deposition of the removed toxins and other particles like proteins present in (i) the blood onto the membrane surface or (ii) inside the porous structure. Unlike the membrane fouling, the concentration polarization is a reversible mechanism, that disappears as soon as the operating pressure is released. Both the membrane fouling and the concentration polarization lead to the reduction of permeability of the membrane, leading to reduction of efficiency of membrane separation process and/or the filter cleaning processes.

Typically, the patients are required to undergo four-hour dialysis for two to three times a week for the rest of their lives or until a kidney transplant. One dialysis session may cost around 4000 INR, which may not be affordable for poor patients. Further, each dialysis requires up to 200 liters of water, expensive consumables and power. Increasing number of dialysis patients coupled with the resource intensive nature of the process call for increased efficiency of the dialysis process, in order to make it a viable and sustainable option.

Further, both the heavier patients and the lighter patients undergo the dialysis process for same duration of four hours. For the heavier patients, four hours of dialysis may not be sufficient to remove the toxins from their body. Incomplete removal of toxins may lead to increase in accumulation of the toxins in the patient's body, which may lead to symptoms like lack of appetite, nausea, tendency to vomits, etc. This condition is called as inadequate dialysis which may be quantified by the ratio Kt/V, lower than the value of 1.2 (Kt/V<1.2). For the lighter patients, the toxins may be removed earlier than four hours due to their low body mass index (i.e. lesser toxins to remove, compared to heavier patients). The lighter patients may be spending more time than required at the dialysis center. This extra dialysis given to the lighter patients corresponds to usage of extra water, consumables and power. Existing studies show that there is no advantage of giving extra dialysis to the patients. It only wastes essential resources.

Some existing studies show that around 50% of the dialysis patients receive inadequate dialysis and they get resultant symptoms that may lead to severely affected quality of life and increased mortality. Thus, the efficiency of filtration needs to be improved to achieve complete removal of the toxins from the patient's body within four hours of dialysis. The rest of the patients are getting extra dialysis than required. If we improve the efficiency of the membrane separation and/or the filter cleaning process, we may be able to reduce the duration of the dialysis and hence, reduce the unnecessary wastage of resources.

Recently, the data from our experiments of monitoring 350 hours of dialysis sessions shows that 53% of sessions delivered inadequate dialysis and the remaining 47% of sessions got extra dialysis. Further, the inadequate dialysis was observed more in heavier patients with weight above 55 kg. Other literature shows around 60% inadequacy in dialysis in developing nations and around 33% inadequacy in dialysis in developed nations.

Existing solution to inadequate dialysis includes high-efficiency dialysis, high-flux dialysis and hemodiafiltration. The data shows that these solutions increase the efficiency by only up to 10% which may not be enough to achieve a prescribed amount of removal (Kt/V>1.2). Further, these solutions require a rate of drawing of blood from the patient to be higher than normal. Further, higher cost of consumables and equipment needed for these solutions may limit their application and scalability.

Similar to the dialysis, problems of reduction in efficiency due to the concentration polarization and the membrane fouling is seen in all the membrane separation processes that use a semi permeable membrane. The reduction in efficiency may also be due to incomplete cleaning of the filter.

Accordingly, there remains a need for an apparatus and method for reducing concentration polarization and/or membrane fouling on a membrane surface in a filter unit which is safe, cost-effective and can improve the efficiency of the membrane separation process and/or the filter cleaning process, and retrofits on to the existing filter.

### SUMMARY

In view of the foregoing, an embodiment herein provides an apparatus that is attached with a filter unit for reducing concentration polarization and/or membrane fouling on a membrane surface in the filter unit during a membrane separation process and/or a filter cleaning process using a non-invasive and non-destructive vibrational energy source. The apparatus comprises a signal generator and an ultrasonic transducer assembly. The signal generator generates electrical signals when there is a fluid flow in the filter unit. The signal generator comprises a converter that is adapted to receive power from a power source and generate the electrical signals in at least one of (i) frequencies, (ii) intensities, or (iii) pulse characteristics. The ultrasonic transducer assembly that receives the electrical signal from the signal generator, comprises an array of transducers, a housing and a coupling medium layer. The array of transducers includes one or more ultrasonic transducers that generate ultrasonic waves when the ultrasonic transducer assembly receives the electrical signals from the signal generator. The housing embeds the one or more ultrasonic transducers to generate the ultrasonic waves in at least one of (i) a perpendicular direction to the filter unit or (ii) at an angle to the filter unit, to ensure maximum exposure of the ultrasonic waves to the membrane surface in the filter unit. The coupling medium layer is placed between the array of transducers and the filter unit to enable the transmission of the ultrasonic waves into the filter unit. During the membrane separation process and/or the filter cleaning process, when the ultrasonic waves that is generated by the array of transducers pass through the filter unit, the ultrasonic waves generate at least one of (i) a turbulence in the flow of fluid or (ii) a vibration on the membrane surface to dislodge particles clogging the membrane surface, thereby reducing the concentration polarization and/or the membrane fouling on the membrane surface of the filter unit, which in turn, increasing the membrane permeability and efficiency of the membrane separation process and/or the filter cleaning process.

In some embodiments, the signal generator comprises a controller that provides information on the type of the electrical signals to be generated by the converter. The controller obtains the information from at least one of (i) a user input in the signal generator, (ii) an input from a program stored in the controller, or (iii) an input from an external device. The external device transmits signals to the signal generator to generate the ultrasonic waves.

In some embodiments, the electrical signals comprise at least one of (i) one or more frequencies in a range of 50 Kilo Hertz (kHz) to 3 Mega Hertz (MHz), (ii) one or more power outputs in a range of 5 Watts (W) to 1 kilowatt (kW), or (iii) a constant signal or signals varying in time with respect to frequency, power output or pulse characteristics. The ultrasonic transducer assembly receives electrical signals from the signal generator using a cable. The generated signals increase the turbulence in the flow of fluid without damaging the membrane surface of the filter unit.

In some embodiments, the filter unit comprises a semi permeable membrane to separate components from a feed solution. In some embodiments, surface profile of the one or more ultrasonic transducers matches surface profile of the filter unit, thereby minimizing the gap between the one or more ultrasonic transducers and the filter unit by filling the coupling medium layer.

In some embodiments, the one or more ultrasonic transducers comprises at least one of (i) similar piezoelectric crystals or (ii) dissimilar piezoelectric crystals. When the array of transducers simultaneously generates the ultrasonic waves in different operating conditions of the electrical signals, the ultrasonic waves generate enhanced turbulence in the flow of fluid, reducing the concentration polarization and/or the membrane fouling to a larger extent.

In some embodiments, the housing is flexible for wrapping around the filter unit and the housing includes a length and a dimension that is suitable for the filter unit of different dimensions and shapes.

In some embodiments, the coupling medium layer is a flexible material that is made up of at least one of a liquid, a semi solid, or a flexible solid material that flows or changes its shape to replace air gaps and occupy the space between the one or more ultrasonic transducers and the filter unit. The coupling medium layer is bonded or unbonded to the housing.

In some embodiments, the apparatus comprises (i) a control unit to configure a mode of operation of the signal generator and (ii) a display unit to display the mode of operation of the signal generator.

In some embodiments, the coupling medium layer comprises at least one of a patch coupling medium layer, or a sheet coupling medium layer. The coupling medium layer is applied on the surface of the one or more ultrasonic transducers, the ultrasonic transducer assembly and the filter unit are immersed into a fluid which acts as a coupling medium

In an aspect, an embodiment herein provides a method for reducing concentration polarization and/or membrane fouling on a membrane surface in a filter unit during a membrane separation process and/or a filter cleaning process using a non-invasive and non-destructive vibrational energy source. The method comprises (a) generating, using a signal generator, electrical signals in at least one of (i) frequencies, (ii) intensities or (iii) pulse characteristics when there is a fluid flow in the filter unit and (b) generating, using an array of transducers, ultrasonic waves when an ultrasonic transducer assembly receives the electrical signals from the signal generator. The ultrasonic waves generate at least one of (i) a turbulence in the flow of fluid or (ii) a vibration on the membrane surface to dislodge particles clogging the membrane surface, thereby reducing the concentration polarization and/or the membrane fouling on the membrane surface of the filter unit, which in turn, increases the membrane permeability and efficiency of the membrane separation process and/or the filter cleaning process.

The apparatus performs one or more operating conditions during the membrane separation process and/or the filter cleaning process. The apparatus is a portable accessory that can be mount on any filter unit. The apparatus removes more toxins within the stipulated time of four hours, which leads to adequate dialysis for heavier patients. For lighter patients, the apparatus removes the same amount of toxins in a shorter duration of time, thereby saving of resources, reducing cost, and increasing the number of patients being treated in a day. The apparatus can be used in many industries that involve pharmaceuticals, dairy products, fruit juices and beverages, etc. The apparatus reduces concentration polarization and/or membrane fouling during the membrane separation process and/or the filter cleaning process and can be used for all the kinds and applications of membrane separation and filter cleaning processes. The usage of the ultrasonic waves, in the apparatus, ensures better cleaning of the filter unit to improve a treatment quality for the subsequent use and increases a lifetime of the filter unit. The apparatus further improves the efficiency of removal of toxins from the blood by 25% compared to the 10% in the existing solutions. The apparatus is safe as it does not require the blood to be drawn from patients at a faster rate and works efficiently on the low blood flow rates as well. The apparatus is cost-efficient compared to the existing solutions or existing dialysis equipment. Further, the apparatus uses noninvasive and non-destructive vibrational energy source for reduction of clogging and significantly improves the efficiency of dialysis without damaging the blood or the membranes of the filter unit.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a system view of an apparatus that reduces concentration polarization and/or membrane fouling on a membrane surface in a filter unit during a membrane separation process and/or a filter cleaning process according to some embodiments herein;

FIG. 2 is an exploded view of a signal generator of FIG. 1 according to some embodiments herein;

FIG. 3 is an exploded view of an ultrasonic transducer assembly of FIG. 1 according to some embodiments herein;

FIG. 4A-C is an exemplary view of a dialysis membrane fiber of the filter unit of FIG. 1 according to some embodiments herein;

FIG. 5 is an exemplary view of the apparatus of FIG. 1 according to some embodiments herein;

FIGS. 6A-6L illustrate exemplary views of the apparatus of FIG. 1 according to some embodiments herein;

FIG. 7A illustrates a graph that depicts experimental data of reduction of urea concentration in blood during dialysis according to some embodiments herein;

FIG. 7B illustrates a graph that depicts experimental data of water output measured from the filter unit used for RO water purification according to some embodiments herein; and

FIG. 8 is a flow diagram that illustrates a method of reducing concentration polarization and/or membrane fouling on a membrane surface in the filter unit during a membrane separation process and/or a filter cleaning process using the apparatus of FIG. 1 according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

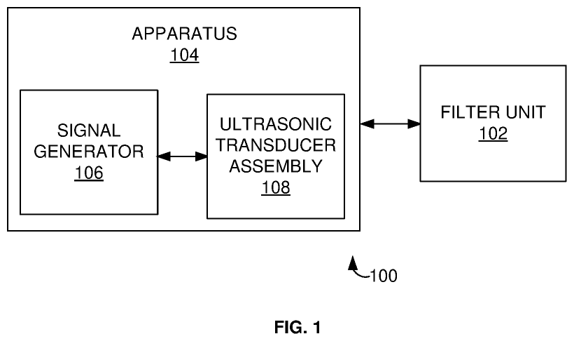

As mentioned, there remains a need for an apparatus and method for reducing concentration polarization and/or membrane fouling on a membrane surface in a filter unit during a membrane separation process and/or a filter cleaning process using a non-invasive and non-destructive vibrational energy source. The embodiments herein achieve this by generating ultrasonic waves in the filter unit to reduce concentration polarization and/or membrane fouling on the membrane surface of the filter unit, thereby increasing the membrane permeability and efficiency of the membrane separation process and/or the filter cleaning process. Referring now to the drawings, and more particularly to FIG. 1 through FIG. 8, where similar reference characters denote corresponding features consistently throughout the figures, there are shown preferred embodiments.

FIG. 1 is a system view 100 of an apparatus 104 that reduces concentration polarization and/or membrane fouling on a membrane surface in a filter unit 102 during a membrane separation process and/or a filter cleaning process according to some embodiments herein. The system view 100 of the apparatus 104 includes a signal generator 106, and an ultrasonic transducer assembly 108. At least one of the apparatus 104 or the ultrasonic transducer assembly 108 is attached to the filter unit 102. The signal generator 106 generates electrical signals when there is a fluid flow in the filter unit 102. The signal generator 106 receives power from a power source and generates electrical signals in at least one of (i) frequencies, (ii) intensities or (iii) pulse characteristics. In some embodiments, the signal generator 106 is a separate or an integrated unit that sends electrical signals to the ultrasonic transducer assembly 108 via a cable. The ultrasonic transducer assembly 108 is mounted on the filter unit 102 that uses a semi-permeable membrane/a membrane to separate components from a feed solution (e.g. blood). The ultrasonic transducer assembly 108 receives the electrical signals from the signal generator 106 and generates ultrasonic waves in at least one of (i) in a perpendicular direction to the filter unit 102 or (ii) at an angle to the filter unit 102. In some embodiments, the ultrasonic transducer assembly 108 may generate a non-invasive and non-destructive vibrational energy source in the form of ultrasonic waves.

During the membrane separation process and/or the filter cleaning process, the ultrasonic waves generated by the ultrasonic transducer assembly pass through the filter unit 102 and the ultrasonic waves generate at least one of (i) a turbulence in the flow of fluid or (ii) a vibration on the membrane surface to dislodge particles clogging the membrane surface, thereby reducing the concentration polarization and/or the membrane fouling on the membrane surface of the filter unit 102, which in turn, increases the membrane permeability and efficiency of the membrane separation process and/or the filter cleaning process. In some embodiments, the electrical signals in the frequency range of 50 Kilo Hertz (kHz) to 3 Mega Hertz (MHz) is generated by the signal generator 106 for reducing the clogging on the membrane surface. It is to be noted that the term ‘ultrasonic’ used in this present embodiment, includes all the frequencies between 50 Kilo Hertz (kHz) and 3 Mega Hertz (MHz), even though the term ‘megasonic’ is used for frequencies above 300 Kilo Hertz (kHz).

When the ultrasonic waves travel in a medium/the feed solution, it causes vibration to the molecules present in the medium. In some embodiments, when the medium is a liquid, these vibrations cause currents within the liquid. The ultrasonic waves cause compression and expansion of air bubbles within the liquid that eventually collapse and produce a shockwave. The currents and the shockwaves cause the turbulence and a stirring effect within the liquid. In some embodiments, the signal generator 106 generates different kinds of electrical signals that lead to generation of different kinds of currents and vibrations that may increase the amount of turbulence within the liquid. The ultrasonic waves induce turbulence in the liquid, which causes dislodging of the layer of solutes or particles clogging the pores/surface of the membrane. In some embodiments, the filter unit 102 is filled with a fluid during the membrane separation process and/or the filter cleaning process. In some embodiments, the application is a dialysis process.

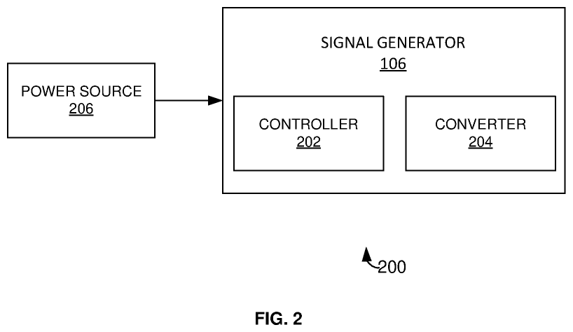

FIG. 2 is an exploded view 200 of the signal generator 106 of FIG. 1 according to some embodiments herein. The exploded view 200 of the signal generator 106 includes a controller 202, and a converter 204. The signal generator 106 is electrically connected to a power source 206. The power source 206 supplies power to the signal generator 106. In some embodiments, the power source 206 is at least one of (ii) an AC supply from the wall socket or another machine or (ii) a DC supply from a storage device or another machine. The controller 202 provides information on the type of the electrical signals to be generated by the converter 202. In some embodiments, the signal generator 106 includes one or more controllers. In some embodiments, the controller 202 provides signals to one or more converters (e.g. the converter 204). In some embodiments, the controller 202 obtains the information from at least one of (i) a user input in the signal generator 106, (ii) an input from a program stored in the controller 202, or (iii) an input from an external device. In some embodiments, the external device transmits signals to the signal generator 106 to generate electrical signals to send to the ultrasonic transducer assembly 108. In some embodiments, the apparatus 104 is controlled by at least one of an automatic mode or triggered by a dialysis machine. In some embodiments, the dialysis machine may provide signals to the signal generator 106 to decide when to send the ultrasonic waves into the filter.

The converter 202 associated with the signal generator 106 is adapted to receive power from the power source 206 and manipulate the received power to make it suitable for generation of the electrical signals. The electrical signals include at least one of (i) one or more frequencies in a range of 50 kHz to 3 MHz, (ii) one or more power outputs in a range of 5 Watts (W) to 1 kilowatt (kW), or (iii) a constant signal or signals varying in time with respect to frequency, power output or pulse characteristics. In some embodiments, the one or more frequencies includes a single frequency (e.g. 200 kHz), multiple frequencies (e.g. 200 kHz, 250 kHz, and 900 kHz) or varying frequencies (e.g. the frequency starts at 50 kHz, increases to 500 kHz within 5 minutes and then reduced back to 50 kHz within 10 minutes). In some embodiments, the one or more power outputs includes a single power output (e.g. 90 watts), multiple power outputs (e.g. 9 watts, 50 watts and 500 watts), and varying power outputs (e.g. the power output starts at 5 watts, increases to 500 watts in steps of 10 watts, for every 2 minutes). In some embodiments, the constant signal or signals may be generated intermittently. In an example embodiment, the signals may be generated for 5 minutes and then stopped for 3 minutes and so on, during dialysis.

In some embodiments, the pulse characteristics include one type of pulse (e.g. sine wave) or multiple types of pulse (e.g. square wave and sawtooth) or varying pulse types (e.g. sine wave for first 5 minutes, then sawtooth for next 15 minutes, etc.). In some embodiments, the frequency in a range of 50 kHz to 3 MHz increases the turbulence in the flow of fluid without damaging the membrane surface of the filter unit 102. The electrical signals generated by the signal generator 106 are transmitted to the ultrasonic transducer assembly 108.

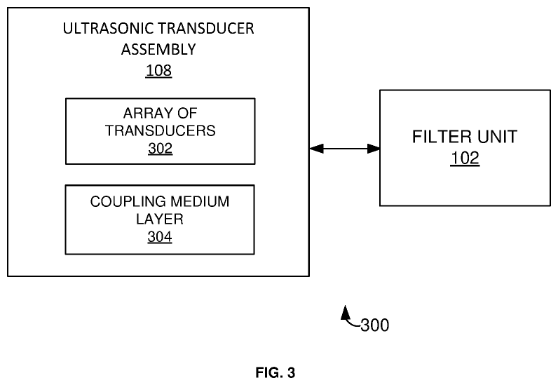

FIG. 3 is an exploded view 300 of the ultrasonic transducer assembly 108 of FIG. 1 according to some embodiments herein. The exploded view 300 of the ultrasonic transducer assembly 108 includes an array of transducers 302, and a coupling medium layer 304. The ultrasonic transducer assembly 108 is flexible to wrap around the filter unit 102. The ultrasonic transducer assembly 108 receives the electrical signals from the signal generator 106. The array of transducers 302 includes one or more ultrasonic transducers that generate ultrasonic waves when the ultrasonic transducer assembly 108 receives the electrical signals from the signal generator 106. In some embodiments, the electrical signals from the signal generator 106 are converted to acoustic energy of single or multiple frequencies in a range of 50 kHz to 3 MHz by the one or more ultrasonic transducers. The one or more ultrasonic transducers includes at least one of (i) similar piezoelectric crystals or (ii) dissimilar piezoelectric crystals. In some embodiments, when the array of transducers 302 simultaneously generates the ultrasonic waves in different operating conditions of the electrical signals, the ultrasonic waves generate enhanced turbulence in the flow of fluid, thereby reducing concentration polarization and/or membrane fouling to a larger extent.

The ultrasonic transducer assembly includes a housing that embeds the one or more ultrasonic transducers to generate the ultrasonic waves in at least one of (i) in a perpendicular distance to the filter unit 102 or (ii) at an angle to the filter unit 102, to ensure maximum exposure of the ultrasonic waves to the membrane surface in the filter unit 102. In some embodiments, the housing is flexible for wrapping around the filter unit 102. In some embodiments, the housing includes a length and a dimension that is suitable for the filter unit 102 of different dimensions and shapes.

Air is a poor conductor of ultrasonic waves. This necessitates the use of another medium to allow for faithful transmission of ultrasonic waves from the surface of the one or more ultrasonic transducers to the filter unit 102. The coupling medium layer 304 is placed between the array of transducers 302 and the filter unit 102 to enable the transmission of the ultrasonic waves into the filter unit 102. In some embodiments, the coupling medium layer 304 is a flexible material that is made up of at least one of a liquid, a semi solid, or a flexible solid material that flows or changes its shape to replace air gaps and occupy the space between the one or more ultrasonic transducers and the filter unit 102. In some embodiments, the coupling medium layer 304 is bonded or unbonded to the housing and/or one or more ultrasonic transducers. In some embodiments, the coupling medium layer 304 includes at least one of a patch coupling medium layer or a sheet coupling medium layer. In some embodiments, the coupling medium layer 304 is applied on surface of the one or more ultrasonic transducers before use, or the ultrasonic transducer assembly 108 and the filter unit 102 are immersed into a fluid which acts as a coupling medium. In some embodiments, a larger sheet of coupling medium is used for the one or more ultrasonic transducers. The ultrasonic waves pass through the filter unit 102, the fluid/liquid inside the filter unit 102, during the membrane separation process and/or the filter cleaning process, acts as the carrier for the ultrasonic waves. The ultrasonic waves reach the membrane surface and generate turbulence in the fluid flow and vibration on the membrane surface to dislodge particles clogging on the membrane surface. In some embodiments, the design of the apparatus 104 enables the use of ultrasonic waves on filter unit 102 for longer periods (i.e. more than 30 minutes). In some embodiments, the surface profile of the one or more ultrasonic transducers matches the surface profile of the filter unit 102, minimizing the gap between the one or more ultrasonic transducers and the filter unit 102 by filling the coupling medium layer 304.

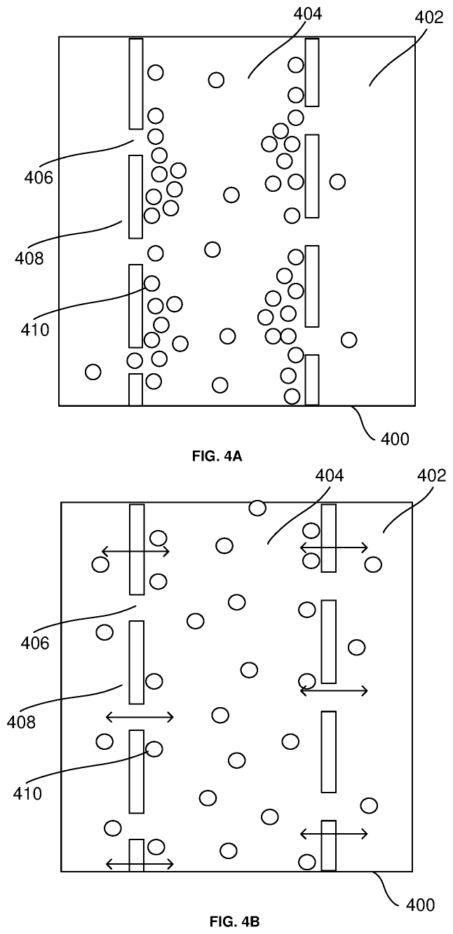

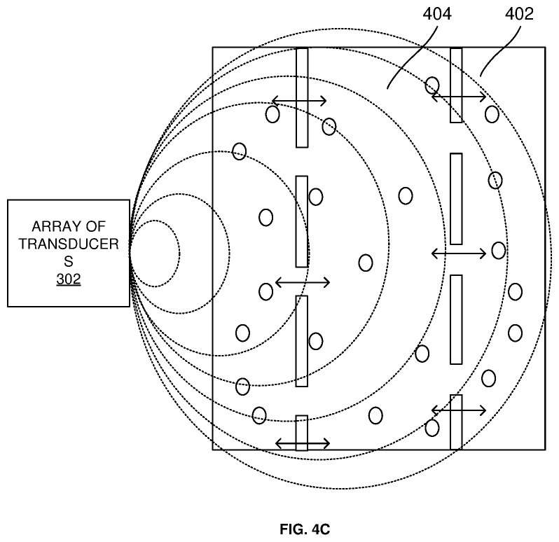

FIG. 4A-C is an exemplary view of a dialysis membrane fiber 400 of the filter unit 102 of FIG. 1 according to some embodiments herein. The exemplary view of the dialysis membrane fiber 400 shows a blood 404, a dialysate 402, pores 406, a membrane 408 and toxins 410. FIG. 4A illustrates that the blood 404 flows through the membrane 408 and the dialysate 402 flows around the membrane 408. Diffusion of toxins happens from the blood 404 into the dialysate 402 through the pores 406 of the membrane 408, as the dialysate is low in concentration of toxins. During this process, the increase in the amount of solutes/particles at the surface of the membrane 408 leads to a formation of concentration boundary layer, which leads to a drop in the efficiency of removal of toxins 410 from the blood 402.

FIG. 4B and FIG. 4C illustrate a stirring effect of the ultrasonic waves on the dialysis membrane fiber 400. The ultrasonic waves that are generated by the ultrasonic transducer assembly 108 generate a turbulence in the fluid flow and/or a vibration on the dialysis membrane fiber 400 to prevent deposition of solutes/particles on the membrane surface. In some embodiments, the solutes/particles deposition on the membrane surface leads to the concentration polarization and/or the membrane fouling. In some embodiments, the concentration polarization and/or the membrane fouling is seen in the membrane separation processes which handle blood (e.g. Hemodialysis, hemodiafiltration, SLED etc.) and it leads to dialysis inadequacy. In some embodiments, the stirring effect of the ultrasonic waves is controlled by the electrical signals that are generated by the signal generator 106. In some embodiments, the frequency range of the ultrasonic waves is 50 kHz to 3 MHz. In some embodiments, the power that is supplied to the signal generator 106 is in a range of 5 W to 1 kilowatt (kW). In some embodiments, when the dialysis membrane filter 400 is cleaned during and/or after the membrane separation process (e.g. dialysis), the membrane permeability and efficiency of the membrane separation process is increased. In some embodiments, the usage of the ultrasonic waves is an efficient and non-interfering method to clean the filter unit 102 during the membrane separation process.

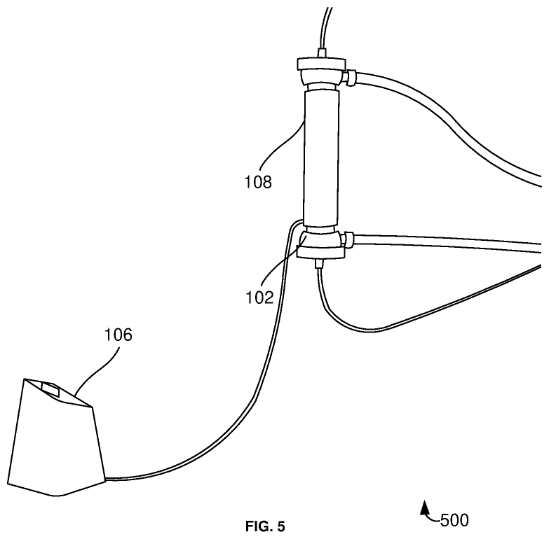

FIG. 5 is an exemplary view 500 of the apparatus 104 of FIG. 1 according to some embodiments herein. The exemplary view 500 of the apparatus 104 includes the signal generator 106, the ultrasonic transducer assembly 108 and the filter unit 102. In some embodiments, the signal generator 106 and the ultrasonic transducer assembly 108 are separate units connected by a cable. The signal generator 106 transmits the electrical signals to the ultrasonic transducer assembly 108 using the cable. The ultrasonic transducer assembly 108 is wrapped around the filter unit 102 to transmit the ultrasonic waves to the filter unit 102.

In some embodiments, the apparatus 104 includes a control unit and a display unit. The control unit configures a mode of operation of the signal generator 106 and/or the ultrasonic transducer assembly 108 and the display unit displays the mode of operation of the signal generator 106 and/or the ultrasonic transducer assembly 108.

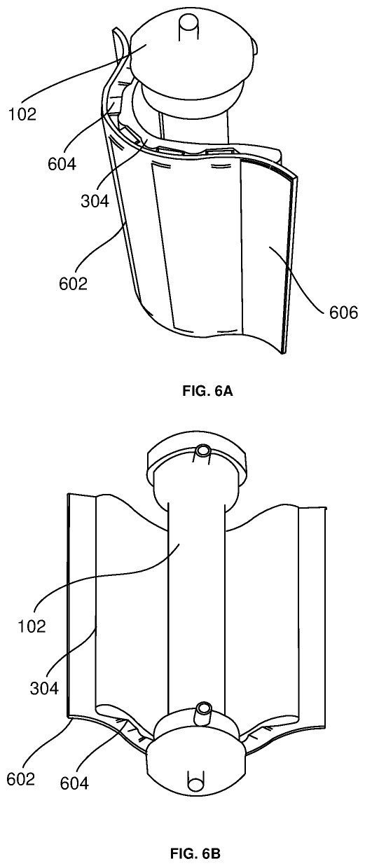

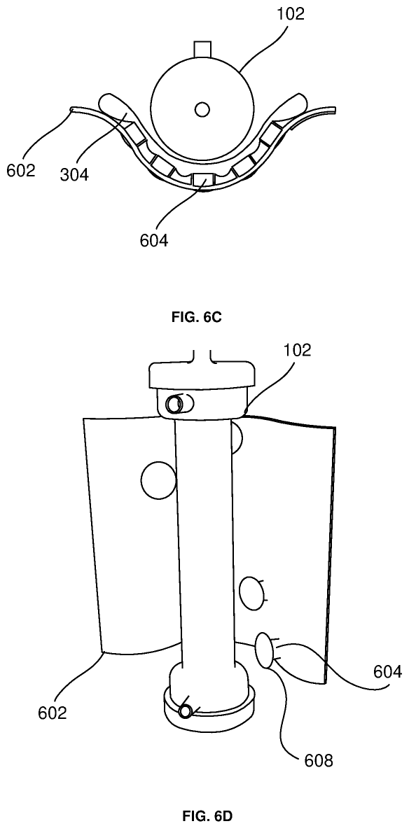

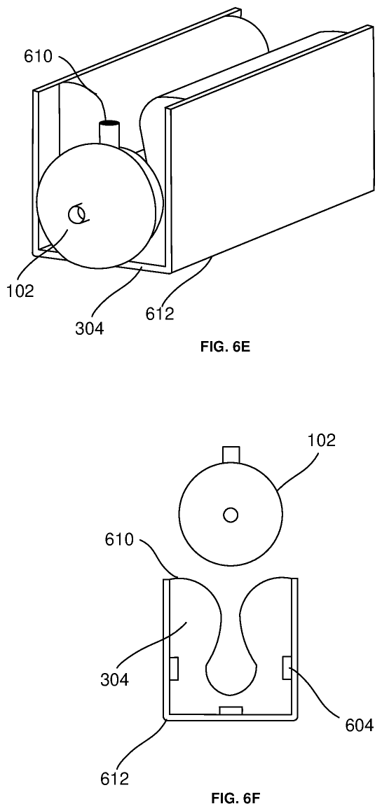

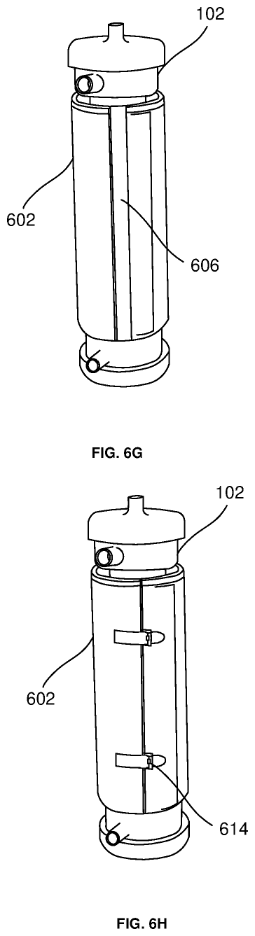

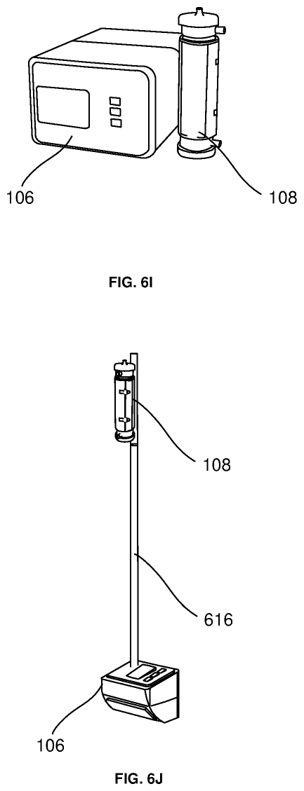

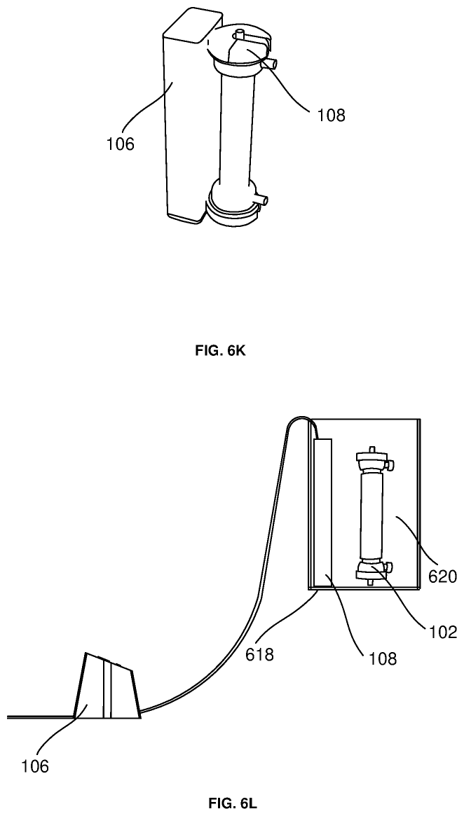

FIGS. 6A-6L illustrate exemplary views of the apparatus 104 of FIG. 1 according to some embodiments herein. FIG. 6A illustrates an example embodiment of the apparatus 104 that includes a housing 602, one or more ultrasonic transducers 604 embedded in the housing 602, and a coupling medium layer 304. The coupling medium layer 304 is provided between the one or more ultrasonic transducers 604 and the filter unit 102. The combination of the housing 602, the one or more ultrasonic transducers 604 and the coupling medium layer 304 is flexible to wrap around the filter unit 102. In some embodiments, the apparatus 104 is attached to the filter unit 102 using Velcro 606. FIG. 6B and FIG. 6C illustrates a front and a top view of the example embodiment of the apparatus 104 of FIG. 6A. The coupling medium layer 304 comprises at least one of a solid with less rigidity or a semi-solid to effectively replace the air gaps between the filter unit 102 and the one or more ultrasonic transducers 604.

FIG. 6D illustrates an example embodiment of the apparatus 104 that includes a coupling medium patch instead of having a single, continuous sheet of the coupling medium layer 304. The coupling medium patch is provided between the one or more ultrasonic transducers 604 and the filter unit 102. The coupling medium patch 608 is bonded to the one or more ultrasonic transducers 604 which in turn are embedded in the housing 602. The housing 602 encloses the one or more ultrasonic transducers 604 and the coupling medium patch 608 to wrap around the filter unit 102. In some embodiments, the coupling medium layer 304 may be applied on the surface of the one or more ultrasonic transducers 604 before attaching the ultrasonic transducer assembly 108 to the filter unit 102.

FIG. 6E illustrates an example embodiment of the apparatus 104 that includes a coupling medium layer 304 enclosed in a film 610 within a support structure 612. In some embodiments, the coupling medium layer 304 comprises a liquid or a semi-solid material. When the filter unit 102 is placed on the film 610, the coupling medium layer 304 gets redistributed to accommodate the filter unit 102 and to eliminate air gaps between the filter unit 102 and the film 610.

FIG. 6F illustrates a top view of the example embodiment of the apparatus 104 of FIG. 6E. In some embodiments, the support structure 612 is not flexible to wrap around the filter unit 102. The one or more ultrasonic transducers 604 are embedded on the support structure 612 and the film 610 is bonded to the support structure 612. The space between the support structure 612 and the film 610 is filled with the coupling medium layer 304.

FIG. 6G illustrates an example embodiment of the apparatus 104 that is attached to the filter unit 102 by using the Velcro 606. This type of apparatus 104 accommodates the filter unit 102 of different diameters that includes small filters and big filters.

FIG. 6H illustrates an example embodiment of the apparatus 104 that is attached to the filter unit 102 using a belt 614. This type of apparatus 104 accommodates the filter unit 102 of different diameters that includes small filters and big filters.

FIG. 6I illustrates an example embodiment of the apparatus 104 that includes the signal generator 106 and the ultrasonic transducer assembly 108 that is combined as a single unit for attaching the filter unit 102 during the membrane separation process and/or the filter cleaning process.

FIG. 6J illustrates an example embodiment of the apparatus 104 that includes the signal generator 106 and the ultrasonic transducer assembly 108 combined as a single unit for attaching the filter unit 102 during the membrane separation process and/or the filter cleaning process. The apparatus 104 comprises a stem 616 that acts as a structural member to support the ultrasonic transducer assembly 108 and to supply the electrical signals from the signal generator 106 to the ultrasonic transducer assembly 108.

FIG. 6K illustrates an example embodiment of the apparatus 104 that includes the signal generator 106 and the ultrasonic transducer assembly 108 is combined as a single unit. The filter unit 102 is adapted to attach to the ultrasonic transducer assembly 108. The ultrasonic transducer assembly 108 sends ultrasonic waves axially into the filter unit 102.

FIG. 6L illustrates an example embodiment of the apparatus 104 that includes the signal generator 106, the ultrasonic transducer assembly 108, the filter unit 102, and a tank 618 which is filled with a liquid or a semi solid to act as the coupling medium 620. The filter unit 102 is adapted to be placed in the tank 618 and the ultrasonic transducer assembly 108 transmits the ultrasonic waves to the filter unit 102 through the coupling medium 620.

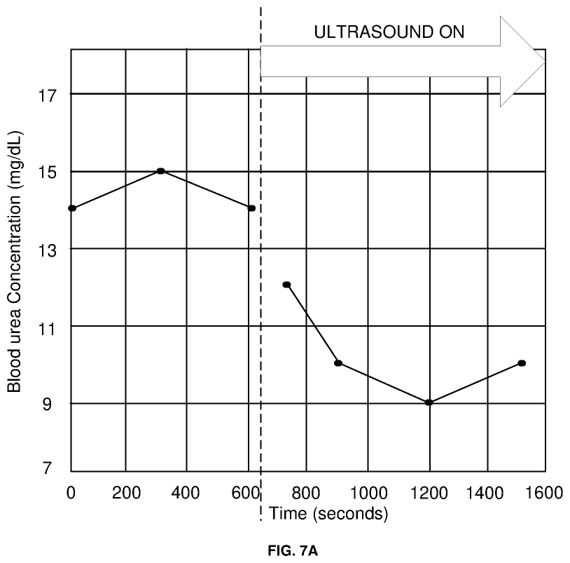

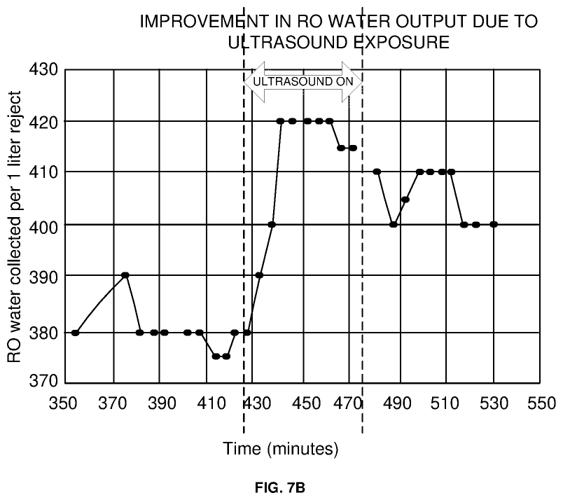

FIG. 7A illustrates a graph that depicts experimental data of the reduction of urea concentration in blood during dialysis according to some embodiments herein. The graph shows a reduction of urea concentration in a range of 12% to 16% immediately and shows the reduction of urea concentration in a range of 23% to 27% over a period time of 10 minutes of passing the ultrasonic waves. No drastic reduction in blood cell count or membrane damage was observed during these experiments, proving that the ultrasonic waves are non-invasive and non-destructive.

FIG. 7B illustrates a graph that depicts experimental data of water output measured from the filter unit 102 used for RO water purification, according to some embodiments herein. The graph shows an increase in the amount of water collected per liter in a range of 8% to 12% of the rejected water. In some embodiments, the water is a reverse osmosis (RO) water. No change in the Total Dissolved Solids (TDS) values of the RO water and rejected water was observed during these experiments, proving that the ultrasonic waves are non-invasive and non-destructive.

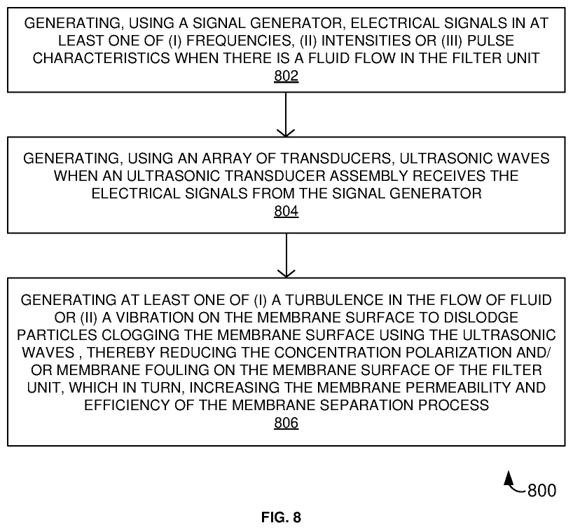

FIG. 8 is a flow diagram that illustrates a method 800 of reducing concentration polarization and/or membrane fouling on a membrane surface in the filter unit 102 during a membrane separation process and/or a filter cleaning process using the apparatus 104 of FIG. 1 according to some embodiments herein. At step 802, the method 800 includes generating electrical signals in at least one of (i) frequencies, (ii) intensities or (iii) pulse characteristics when there is a fluid flow in the filter unit 102 using the signal generator 106. At step 804, the method 800 includes generating ultrasonic waves when the ultrasonic transducer assembly 108 receives the electrical signals from the signal generator 106 using the array of transducers 302. At step 806, the method 800 includes generating at least one of (i) a turbulence in the flow of fluid or (ii) a vibration on the membrane surface to dislodge particles clogging the membrane surface using the ultrasonic waves, thereby reducing the concentration polarization and/or membrane fouling on the membrane surface of the filter unit 102, which in turn, increasing the membrane permeability and efficiency of the membrane separation process and/or filter cleaning process.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

I/We claim:

1. An apparatus (104) that is attached with a filter unit (102) for reducing concentration polarization and/or membrane fouling on membrane surface in the filter unit (102) during a membrane separation process and/or a filter cleaning process using a non-invasive and non-destructive vibrational energy source, wherein the apparatus (104) comprises:
a signal generator (106) that generates electrical signals when there is a fluid flow in the filter unit (102), wherein the signal generator (106) comprises
a converter (204) that is adapted to receive power from a power source (206) and generate the electrical signals in at least one of (i) frequencies, (ii) intensities or (iii) pulse characteristics;
an ultrasonic transducer assembly (108) that receives the electrical signals from the signal generator (106), wherein the ultrasonic transducer assembly (108) comprises,
an array of transducers (302) that includes one or more ultrasonic transducers (604) that generate ultrasonic waves when the ultrasonic transducer assembly (108) receives the electrical signal from the signal generator (106);
a housing (602) that embeds the one or more ultrasonic transducers (604) to generate the ultrasonic waves in at least one of (i) in a perpendicular direction to the filter unit (102) or (ii) at an angle to the filter unit (102), to ensure maximum exposure of ultrasonic waves to the membrane surface in the filter unit (102);
a coupling medium layer (304) that is placed between the array of transducers (302) and the filter unit (102) to enable the transmission of the ultrasonic waves into the filter unit (102),
wherein, during a membrane separation process and/or a filter cleaning process, when the ultrasonic waves that is generated by the array of transducers (302) pass through the filter unit (102), the ultrasonic waves generate at least one of (i) a turbulence in the flow of fluid or (ii) a vibration on the membrane surface to dislodge particles clogging the membrane surface, thereby reducing the concentration polarization and/or the membrane fouling on the membrane surface of the filter unit (102), which in turn, increases the membrane permeability and efficiency of the membrane separation process and/or the filter cleaning process.

2. The apparatus (104) as claimed in claim 1, wherein the signal generator (106) comprises a controller (202) that provides information on the type of the electrical signals to be generated by the converter (204), wherein the controller (202) obtains the information from at least one of (i) a user input in the signal generator (106), (ii) an input from a program stored in the controller (202), or (iii) an input from an external device, wherein the external device transmits signals to the signal generator (106) to generate the ultrasonic waves.

3. The apparatus (104) as claimed in claim 1, wherein the electrical signals comprise at least one of (i) one or more frequencies in a range of 50 Kilo Hertz (kHz) to 3 Mega Hertz (MHz), (ii) one or more power outputs in a range of 5 Watts (W) to 1 kilowatt (kW), or (iii) a constant signal or signals varying in time with respect to frequency, power output or pulse characteristics, wherein the ultrasonic transducer assembly (108) receives electrical signals from the signal generator (106) using a cable, wherein the generated signals increase the turbulence in the flow of fluid without damaging the membrane surface of the filter unit (102).

4. The apparatus (104) as claimed in claim 1, wherein a surface profile of the one or more ultrasonic transducers (604) matches a surface profile of the filter unit (102), thereby minimizing the gap between the one or more ultrasonic transducers (604) and the filter unit (102) by filling the coupling medium layer (304).

5. The apparatus (104) as claimed in claim 1, wherein the one or more ultrasonic transducers (604) comprises at least one of (i) similar piezoelectric crystals or (ii) dissimilar piezoelectric crystals, wherein when the array of transducers (302) simultaneously generate the ultrasonic waves in different operating conditions of the electrical signals, the ultrasonic waves generate enhanced turbulence in the flow of fluid, reducing concentration polarization and/or membrane fouling to a larger extent.

6. The apparatus (104) as claimed in claim 1, wherein the housing (602) is flexible for wrapping around the filter unit (102), wherein the housing (602) includes a length and a dimension that is suitable for the filter unit (102) of different dimensions and shapes.

7. The apparatus (104) as claimed in claim 1, wherein the coupling medium layer (304) is a flexible material that is made up of at least one of a liquid, a semi solid, or a flexible solid material that flows or changes its shape to replace air gaps and occupy the space between the one or more ultrasonic transducers (604) and the filter unit (102), wherein the coupling medium layer (304) is bonded or unbonded to the housing (602) and/or the one or more ultrasonic transducers (604).

8. The apparatus (104) as claimed in claim 1, wherein the apparatus (104) comprises (i) a control unit to configure a mode of operation of the signal generator (106) and (ii) a display unit to display the mode of operation of the signal generator (106).

9. The apparatus (104) as claimed in claim 1, wherein the coupling medium layer (304) comprises at least one of a patch coupling medium layer, or a sheet coupling medium layer, wherein the coupling medium layer (304) is applied on the surface of the one or more ultrasonic transducers (604) before use, or the ultrasonic transducer assembly (108) and the filter unit (102) are immersed into a fluid which acts as a coupling medium (620).

10. A method for reducing concentration polarization and/or membrane fouling on a membrane surface in a filter unit (102) during a membrane separation process and/or a filter cleaning process using a non-invasive and non-destructive vibrational energy source, wherein the method comprises;
generating, using a signal generator (106), electrical signals in at least one of (i) frequencies, (ii) intensities or (iii) pulse characteristics when there is a fluid flow in the filter unit (102); and
generating, using an array of transducers (302), ultrasonic waves when an ultrasonic transducer assembly (108) receives the electrical signals from the signal generator (108), wherein the ultrasonic waves generate at least one of (i) a turbulence in the flow of fluid or (ii) a vibration on the membrane surface to dislodge particles clogging the membrane surface, thereby reducing the concentration polarization and/or membrane fouling on the membrane surface of the filter unit (102), which in turn, increases the membrane permeability and efficiency of the membrane separation process and/or filter cleaning process.
